(19) United States
(12) Patent Application Publication
(10) Pub. No.: US 2006/0184729 A1
(43) Pub. Date: Aug. 17, 2006

(54) Device, method, and computer product for disk management

(75) Inventor: Toshihide Yanagawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/130,462

(22) Filed: May 16, 2005

(30) Foreign Application Priority Data
Feb. 17, 2005 (JP) 2005-041031

(51) Int. Cl. G06F 12/00

(52) U.S. Cl. 711/112

(57) ABSTRACT

A disk management device manages writing of data in a plurality of disks. The disk management device includes an application and a buffer. A plurality of storing units temporarily stores therein the same data that is present in the buffer, and a writing unit writes the data present in the storing units into corresponding disks. When data is successfully written into any one disk, or when predetermined time passes, a notifying unit notifies the application whether the data is successfully written into the disks.

### BACKGROUND OF THE INVENTION

1) Field of the Invention

The present invention relates to a technology for managing writing of data in a disk.

2) Description of the Related Art

Applications in computers perform mirroring to prevent data loss when storing data. Mirroring is performed by storing the same data in a plurality of disk devices, so that when data is lost from one disk device, it can be recovered from another disk device.

However, the problem with mirroring is that the application cannot move on to the next processing unless data writing into all of the disk devices is completed.

For example, data cannot be written when there is a failure in one of the disk devices, or data writing is delayed when there is a failure in the wiring connecting the disk device and the computer. In such cases, the application waits until data writing is completed or a writing error is notified. Therefore, it takes considerable time for the processing to end.

Japanese Patent Application Laid Open No. H11-53120 discloses a technology to overcome this problem. Specifically, when data is being written in a disk device, and there is no notification within predetermined time duration from the disk device that the writing processing has ended, information that an error has occurred is notified to the application.

However, if the writing processing proceeds even slightly during the monitored time duration, a writing error is not notified. In other words, the application cannot recognize errors that cause the processing to slow down. This conventional technology is a best-effort type delay-monitoring arrangement, and does not ensure completion of the writing processing within predetermined time duration.

To prevent a delay when the writing processing slows down, it is imperative to ensure that a response (i.e., information on whether the data is successfully written) is notified to the application within predetermined time duration.

### SUMMARY OF THE INVENTION

It is an object of the present invention to at least solve the problems in the conventional technology.

According to an aspect of the present invention, a disk management device that manages writing of data in a disk, including an application that executes jobs to manage the writing of the data in the disk, and a buffer that temporarily stores the data, the disk management device includes a storing unit that temporarily stores therein the same data that is present in the buffer; a writing unit that writes the data present in the storing unit into the disk; and a notifying unit that notifies, within predetermined time duration, the application whether the data is successfully written by the writing unit into the disk.

According to another aspect of the present invention, a method of managing writing of data in a disk in a disk management device, the disk management device including an application that executes jobs to manage the writing of the data in the disk; and a buffer that temporarily stores the data, includes storing temporarily in a storing unit the data present in the buffer; writing the same data that is present in the storing unit into the disk; and notifying, within predetermined time duration, the application whether the data is successfully written at the writing into the disk.

According to still another aspect of the present invention, a computer-readable recording medium stores therein a computer program that causes a computer to implement the above method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a disk management device according to an embodiment of the present invention;

FIG. 2 is a functional block diagram of a driver shown in FIG. 1;

FIG. 3 is a flowchart to a processing procedure performed by the disk management device shown in FIG. 1; and

FIG. 4 is a functional block diagram of a computer that executes a disk management program according to the present invention.

### DETAILED DESCRIPTION

Exemplary embodiments of the present invention will be described below with reference to accompanying drawings. The present invention is not limited to these embodiments.

A disk management device according to the present invention performs mirroring by writing data in disk devices as described below. Data present in a buffer is copied to other memory sections in the device, and the data copied to the memory sections are then written in the disk devices. When the data writing in any one of the disk devices is completed, the disk management device notifies an application that the data writing is completed.

When the disk management device cannot acquire within predetermined time duration a notification that the data writing is completed or that an error has occurred, the disk management device unconditionally notifies the application that an error has occurred.

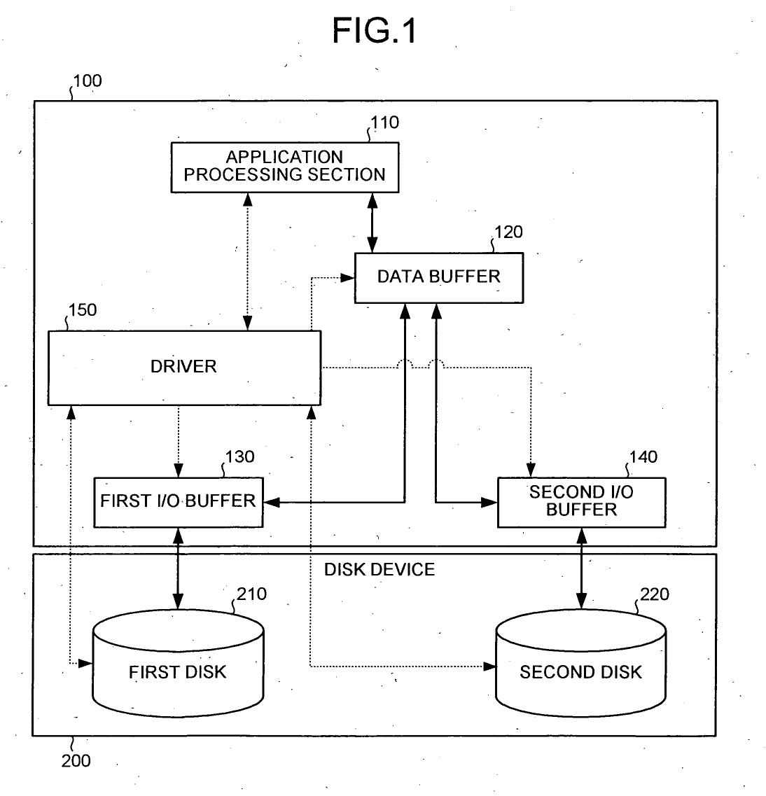

FIG. 1 is a functional block diagram of a disk management device 100 according to an embodiment of the present invention. The disk management device 100 includes an application processing section 110, a data buffer 120, a first input/output (I/O) buffer 130, a second I/O buffer 140, and a driver 150.

The application processing section 110 executes predetermined jobs. The data buffer 120 temporarily stores data to be written in and read from a disk device 200. The disk device 200 stores data received from the disk management device 100, and includes a first disk 210 and a second disk 220 both for storing data.

The data stored in the data buffer 120 is temporarily stored in the first I/O buffer 130 and the second I/O buffer 140 before being stored in the disk device 200. Therefore, data can be quickly released from the data buffer 120, without waiting for a notification that data writing in the disk device 200 is completed.

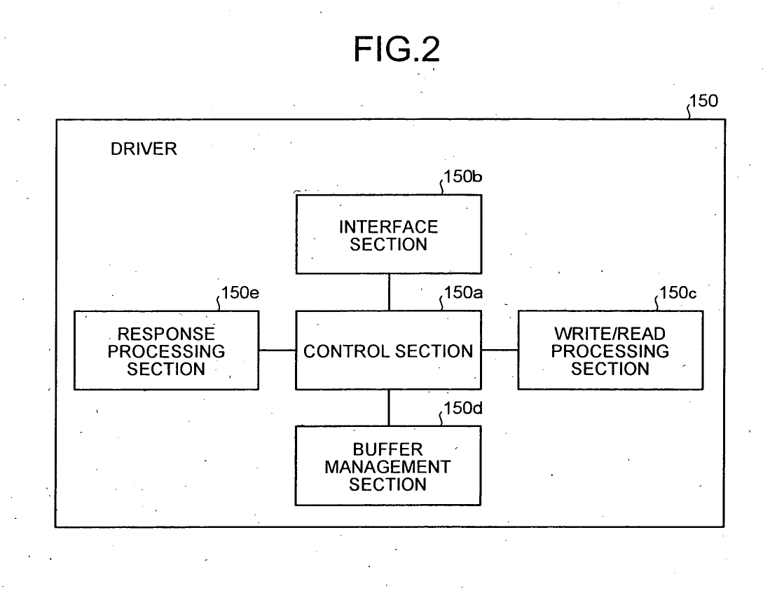

FIG. 2 is a functional block diagram of the driver 150. The driver 150 includes a control section 150a, an interface section 150b, a write/read processing section 150c, a buffer management section 150d, and a response processing section 150e.

The control section 150a controls all the sections of driver 150, the interface section 150b communicates with the application processing section 110, the data buffer 120, the first I/O buffer 130, the second I/O buffer 140, and the disk device 200.

When a notification to write data is received from the application processing section 110, the write/read processing section 150c writes data present in the first I/O buffer 130 into the first disk 210, and writes data present in the second I/O buffer 140 into the second disk 220.

When a notification to read data from the disk device 200 is received from the application processing section 110, the write/read processing section 150c reads the corresponding data from the first disk 210 or the second disk 220. The data read from the first disk 210 is stored in the first I/O buffer 130, and the data read from the second disk 220 is stored in the second I/O buffer 140.

The buffer management section 150d manages the data buffer 120, the first I/O buffer 130, and the second I/O buffer 140. Specifically, when a notification to write data is received from the application processing section 110, the buffer management section 150d copies the data present in the data buffer 120 to the first I/O buffer 130 and the second I/O buffer 140.

When a notification to read data is received from the application processing section 110, the buffer management section 150d copies the data present in either one of the first I/O buffer 130 or the second I/O buffer 140 (the successfully written data) to the data buffer 120.

When the response processing section 150e acquires, from the disk device 200, information as to whether data is successfully written (hereinafter, “write information”), the response processing section 150e notifies the write information to the application processing section 110. The response processing section 150e starts counting when the notification to write data is received from the application processing section 110. When write information is not acquired from the disk device 200 within predetermined time duration, the response processing section 150e unconditionally notifies an error to the application processing section 110.

When a notification that data is successfully written in a disk is received, and another notification that the same data is successfully written in another disk is subsequently received within the predetermined time duration, the response processing section 150e does not notify the application processing section 110 of the first write information.

For example, assume that a notification that data is successfully written in the first disk 210 is received, and another notification that the same data is successfully written in the second disk 220 is subsequently received. In this case, the response processing section 150e does not notify the write information regarding the first disk 210 to the application processing section 110, but notifies the write information regarding the second disk 220 to the application processing section 110.

Moreover, when two sets of write information for the same data are consecutively received, and the latter is information on unsuccessful writing, the response processing section 150e notifies only the information on successful writing to the application processing section 110.

For example, when data writing in the first disk 210 is successful, and data writing in the second disk 220 is unsuccessful, the response processing section 150e notifies the application processing section 110 that data writing is successfully completed.

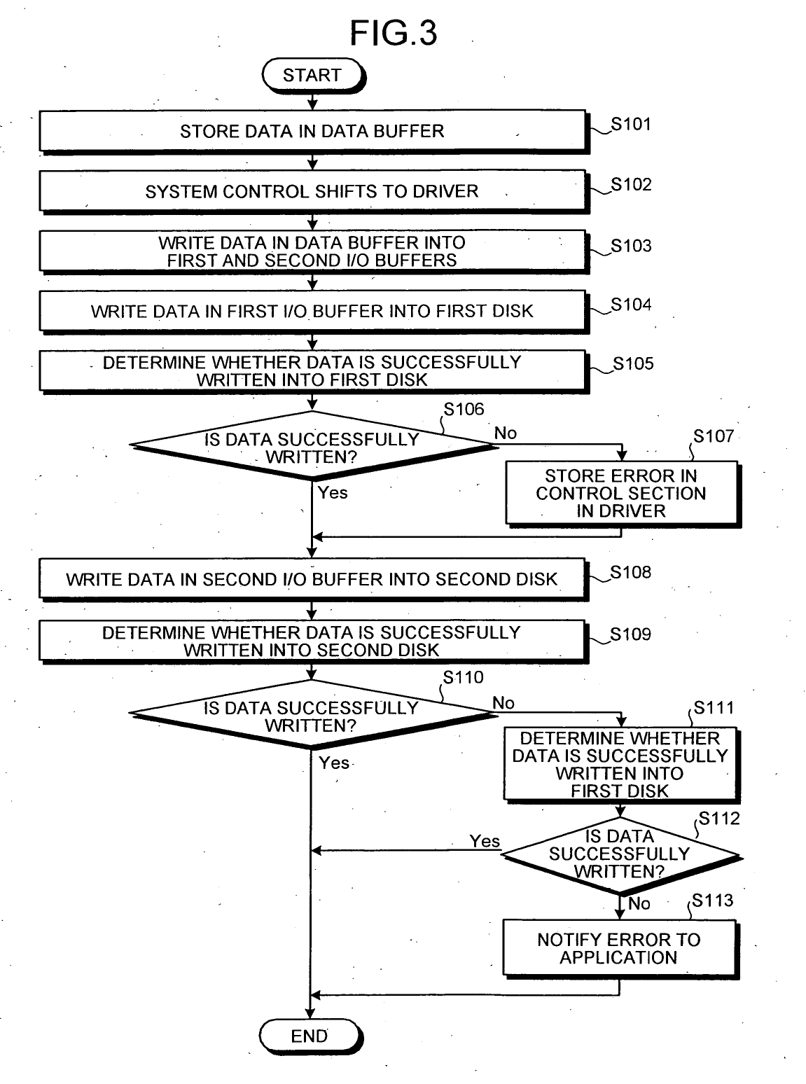

FIG. 3 is a flowchart of a processing procedure performed by the disk management device 100. The application processing section 110 stores data in the data buffer 120 (step S101), and the system control shifts to the driver 150 (step S102).

The driver 150 writes the data present in the data buffer 120 into both the first I/O buffer 130 and the second I/O buffer 140 (step S103), and writes the data present in the first I/O buffer 130 into the first disk 210 (step S104). The first disk 210 and the second disk 220 send write information to the driver 150 when the data is successfully written in the respective disks.

Subsequently, the driver 150 determines whether the data is successfully written in the first disk 210 based on whether the write information is received from the first disk 210 (step S105). When the driver 150 determines that the data writing is unsuccessful (No at step S106), an error is stored in the control section 150a of the driver 150 (step S107).

On the other hand, when the driver 150 determines that the data writing is successful (Yes at step S106), the system control proceeds to step S108.

At step S108 the driver 150 writes the data present in the second I/O buffer 140 into the second disk 220, and determines whether the data is successfully written in the second disk 220 based on whether write information is received from the second disk 220 (step S109). When the driver 150 determines that the data writing is successful (Yes at step S110) the processing ends. When the driver 150 determines that the data writing is unsuccessful (No at step S110), the driver 150 determines whether the data writing in the first disk 210 is successful (refers to the information at step S107 to determine whether an error is stored) (step S111), and when the data writing in the first disk 210 is successful (Yes at step S112), the processing ends. When the data writing in the first disk 210 is unsuccessful (No at step S112), the driver 150 notifies an error to the application (step S113).

When the driver 150 does not acquire write information within the predetermined time duration after data writing starts, the corresponding writing processing is stored as an error in the control section 150a. This error is stored even when the processing procedures in the flowchart of FIG. 3 are not completed.

The writing into the second disk 220 (step S108) can be executed before it is determined that data is successfully written into the first disk 210 (step S105).

In the disk management device 100, the driver 150 copies the data present in the data buffer 120 into both the first I/O buffer 130 and the second I/O buffer 140, writes the data present in the first I/O buffer 130 into the first disk 210, and writes the data present in the second I/O buffer 140 into the second disk 220. As soon as it is determined that data writing into either one of the disks is successful, the driver 150 notifies the write information to the application processing section 110. Therefore, a delay in the processing is prevented.

Moreover, when write information cannot be acquired from the disk device 200 within predetermined time duration, the driver 150 notifies an error to the application processing section 110. Therefore, it is possible to ensure that a response (i.e., information on whether the data is successfully written) is notified to the application within predetermined time duration.

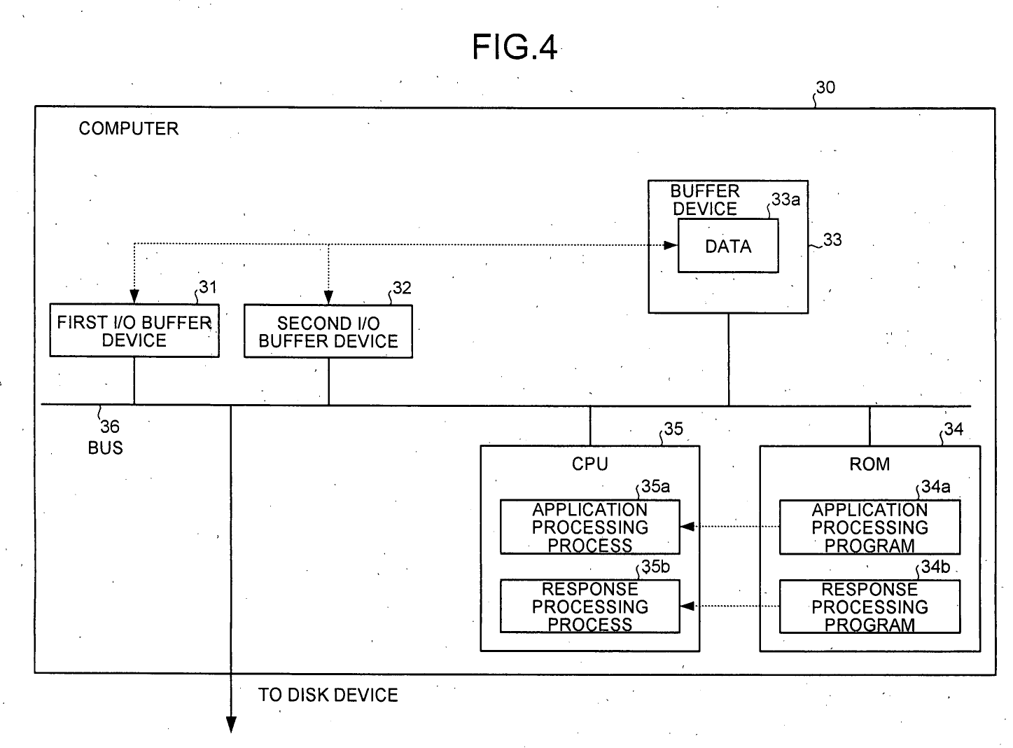

The method according to the embodiment can be implemented on a computer by executing a computer program on the computer. The computer program can be stored in a computer-readable recording medium or distributed downloaded from a server. FIG. 4 is a functional block diagram of a computer 30 that executes the computer program.

The computer 30 includes a first I/O buffer device 31, a second I/O buffer device 32, a buffer device 33, a read-only memory (ROM) 34, a central processing unit (CPU) 35, and a bus 36 that connects these components. The first I/O buffer device 31, the second I/O buffer device 32, and the buffer device 33 correspond to the first I/O buffer 130, the second I/O buffer 140, and the data buffer 120 shown in FIG. 1, respectively.

The ROM 34 stores an application processing program 34a and a response processing program 34b.

The CPU 35 reads the programs 34a and 34b from the ROM 34, and executes the programs 34a and 34b. Accordingly, the programs 34a and 34b function as an application processing process 35a and a response processing process 35b, respectively. The application processing process 35a corresponds to the application processing section 110 shown in FIG. 1, and the response processing process 35b corresponds to the driver 150 shown in FIG. 1. The CPU 35 copies data 33a stored in the buffer device 33 to the first I/O buffer device 31 and the second I/O buffer device 32. The data present in the first I/O buffer device 31 and the second I/O buffer device 32 are stored in corresponding disks.

The programs 34a and 34b do not necessarily have to be stored in the ROM 34 beforehand. Alternatively, the programs 34a and 34b can be stored in a portable physical media, a fixed physical media, or in other computers (or servers), so that the computer 30 reads the programs from the media to execute the programs. Examples of the portable physical media are flexible disks (FDs), compact-disc read-only memories (CD-ROMs), magneto-optical (MO) disks, digital versatile discs (DVDs), and integrated circuit (IC) cards that are inserted in computers. The example of the fixed physical media is a hard disk drive (HDD) that is provided inside or outside the computer 30. The other computers (or servers) are connected to the computer 30 via public lines, the Internet, a local area network (LAN), or a wide area network (WAN).

According to the present invention, the application can move on to the next processing without waiting for completion of the mirroring so that the overall efficiency can be increased.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk management device that manages writing of data in a disk, including an application that executes jobs to manage the writing of the data in the disk, and a buffer that temporarily stores the data, the disk management device comprising:
a storing unit that temporarily stores therein the same data that is present in the buffer;
a writing unit that writes the data present in the storing unit into the disk; and
a notifying unit that notifies, within predetermined time duration, the application whether the data is successfully written by the writing unit into the disk.

2. The disk management device according to claim 1, wherein there is a plurality of the storing units and equal number of the disks, and the writing unit writes data present in a storing unit into a corresponding disk.

3. The disk management device according to claim 2, wherein the notifying unit notifies the application that the data is successfully written into the disks when the notifying unit determines that data present in any one of the storing units is successfully written into a corresponding disk.

4. The disk management device according to claim 1, wherein the notifying unit notifies an error to the application when the notifying unit cannot determine, within the predetermined time duration, that the data present in the storing unit is successfully written into the disk.

5. The disk management device according to claim 2, wherein the notifying unit notifies an error to the application when the notifying unit cannot determine, within the predetermined time duration, that the data present in the storing units are successfully written into the disks.

6. A computer-readable recording medium that stores therein, a computer program that causes a computer to manage writing of data in a disk in a disk management device, the disk management device including
an application that executes jobs to manage the writing of the data in the disk; and
a buffer that temporarily stores the data,
wherein the program causes a computer to execute:
storing temporarily in a storing unit the same data that is present in the buffer;
writing the data present in the storing unit into the disk; and
notifying, within predetermined time duration, the application whether the data is successfully written at the writing into the disk.

7. The computer-readable recording medium according to claim 6, wherein the disk management device includes a plurality of the storing units and equal number of the disks, and the writing includes writing data present in a storing unit into a corresponding disk.

8. The computer-readable recording medium according to claim 7, wherein the notifying includes notifying the application that the data is successfully written into the disks when it is determined at the notifying that data present in any one of the storing units is successfully written into a corresponding disk.

9. The computer-readable recording medium according to claim 6, wherein the notifying includes notifying an error to the application when it cannot be determined, within the predetermined time duration, at the notifying that the data present in the storing unit is successfully written into the disk.

10. The computer-readable recording medium according to claim 7, wherein the notifying includes notifying an error to the application when it cannot be determined, within the predetermined time duration, at the notifying that the data present in the storing units are successfully written into the disks.

11. A method of managing writing of data in a disk in a disk management device, the disk management device including an application that executes jobs to manage the writing of the data in the disk; and
a buffer that temporarily stores the data,
the method comprising:
storing temporarily in a storing unit the data present in the buffer;
writing the same data that is present in the storing unit into the disk; and
notifying, within predetermined time duration, the application whether the data is successfully written at the writing into the disk.

12. The method according to claim 11, wherein the disk management device includes a plurality of the storing units and equal number of the disks, and the writing includes writing data present in a storing unit into a corresponding disk.

13. The method according to claim 12, wherein the notifying includes notifying the application that the data is successfully written into the disks when it is determined at the notifying that data present in any one of the storing units is successfully written into a corresponding disk.

14. The method according to claim 11, wherein the notifying includes notifying an error to the application when it cannot be determined, within the predetermined time duration, at the notifying that the data present in the storing unit is successfully written into the disk.

15. The method according to claim 12, wherein the notifying includes notifying an error to the application when it cannot be determined, within the predetermined time duration, at the notifying that the data present in the storing units are successfully written into the disks.
